(19) United States
(12) Patent Application Publication
(10) Pub. No.: US 2012/0241480 A1
(43) Pub. Date: Sep. 27, 2012

(54) CLOSURE

(75) Inventors: Derek John Hindle, Norfolk (GB); Jamie Fox, Norfolk (GB)

(73) Assignee: OBRIST CLOSURES SWITZERLAND GMBH, Reinach (CH)

(21) Appl. No.: 13/395,962

(22) PCT Filed: Aug. 26, 2010
(86) PCT No.: PCT/GB2010/001609

§ 371 Date: Jun. 5, 2012

(30) Foreign Application Priority Data
Sep. 14, 2009 (GB) 0916083.9

(51) Int. Cl. B65D 41/58; B65D 45/00; B65D 43/14; B29C 45/18

(52) U.S. Cl. 222/566; 264/328.1; 215/280; 215/250; 215/235; 222/541.9; 222/556

(57) ABSTRACT

A closure (1) for a container, comprises a body (2) and an insert (3): The insert has a retaining section (36) for fitting it into the body (2). The retaining section (36) has a part engageable by a container neck such that, in use, the insert becomes trapped between the neck and the body. The body includes a jaw portion (30; 32) which clamps onto the container to trap the insert (3).

### FIELD OF THE INVENTION

The present invention relates generally to a closure and more particularly to a closure formed in two parts.

### BACKGROUND OF THE INVENTION

Provision of a closure formed from two parts may allow different materials to be used for each part. The material properties of each material to be more closely matched to the function of that particular part of the closure. For example, it may be advantageous to provide a lid or body which is particularly rigid, whereas a part of a closure intended to seal could advantageously be formed from a more resilient material, suitable for sealing. Construction of a closure from two materials may, however, lead to complications in manufacture and assembly processes. It can, for example, be expensive to produce two separate pieces, difficult to assemble two pieces prior to fixing that closure to a container, or difficult to ensure both parts are securely affixed to a container.

### SUMMARY OF THE INVENTION

According to an aspect of the present invention is provided a closure for a container, comprising: a body and an insert; the insert having a retaining section for fitting it into the body and the section having a part engageable by a container neck such that the insert becomes trapped between the neck and the body in use and in which the body includes a jaw portion which clamps onto the container to trap the insert.

In some embodiments the body and the insert are formed separately and assembled, connected or unconnected, onto a container whereupon the insert becomes trapped between the body and the container. In other embodiments the body and insert are formed together, for example by sequential moulding. The integrally formed product is then applied to a container, at which point the insert becomes trapped.

The retaining section may be a marginal section and may comprise a flange.

The retaining section may comprise a sealing ring.

According to a further aspect of the present invention, there is provided a closure comprising a body defining a dispensing aperture and comprising a jaw engageable with a lip, on a container having an opening, to secure said closure to said container; an insert, said insert comprising a sealing ring locatable within said dispensing aperture, wherein the jaw is operable to exert a clamping force on the sealing ring to retain the insert within the dispensing aperture.

This aspect recognises that using the body and its interaction with the container on which the closure is to be placed, it is possible to utilise a sealing ring in such a way that it can retain the insert in position on the closure. Using a jaw which cooperates with a lip on the container can provide a strong bond for clamping the sealing ring to the remainder of the closure and the container such that the insert is retained within the dispensing aperture.

The body may be formed from a first material, and the insert may be formed from a second material. The second material may be more resilient than the first material. The first material may be substantially rigid. The second material may be resilient, or substantially deformable.

The insert may further comprise a tear off portion, removable to allow dispensing through said container opening, and the jaw exerts a clamping force on the sealing ring to retain the insert sealingly within the dispensing aperture when the tear-off portion is removed.

When forming ring pull arrangements from plastic materials, different materials may be more or less suitable for forming ring pulls, since the material must be torn when the ring pull is removed. There therefore may be a conflict between the choice of material for a closure and the choice of material for the ring pull component for that closure.

There are materials which make are suitable for a ring pull component and also suitable for use as a sealing element.

Providing a closure constructed from two materials, in which one of the materials can be used for both a ring pull component and a seal element requires that, on application of a force to remove the ring pull arrangement the two piece closure tears in a suitable position, and the seal element is retained.

The body, insert, and sealing ring may be integrally formed. The body, insert, and sealing ring may be integrally moulded. In one embodiment, the body, insert, and sealing ring may form a unitary bi-injection moulded element.

Moulding the sealing element, insert and rigid body, despite those elements potentially having different material properties, as one, is possible by utilising a sequential moulding or bi-injection moulding technique. Bi-injection moulding allows more than one material to be used during the moulding process. Accordingly it is possible to mould for example, the sealing ring and insert and then sequentially mould the body. The sequentially moulding technique allows the body and insert to be formed as one, and also allows chemical bonding to occur along the moulding interface between two materials. If two materials are used, dependent on the properties of the two materials, that chemical bonding may be weak or strong.

In one embodiment the jaw may exert a clamping force on the moulding interface between the body and sealing ring. The chemical bond formed by sequential moulding may not itself be sufficient to reliably hold together the sealing ring and body. This may be particularly true if the insert further comprises a tear off portion. In this instance, it is particularly advantageous to arrange the jaw on the body to provide a clamping force on the sealing ring to hold the insert in position. Typically, the moulding interface will be provided on the sealing ring and thus exertion of the clamping force on the moulding interface serves to reinforce the bond formed by sequential moulding.

The sealing ring may comprise a substantially annular flange.

The body may be formed from polypropylene. The body may be formed from a plastics material having substantially similar properties. Polypropylene is particularly strong, rigid and provides the closure with sufficient strength for retention on a container. Provision of a substantially rigid body may also enable “snap fit” application of the closure to a container with application of a top load.

The insert may be formed from low density polyethylene. The insert may be formed from a plastics material having substantially similar properties. Low density polyethylene is particularly soft and resilient and thus results in a resilient seal having good sealing properties. Furthermore, low density polyethylene has a low tear resistance which allows a user to easily pull out a tear off portion from the insert, if provided.

The closure may further include a lid for closing the closure, connectable to the body. The lid may engage with the body by means of a screw arrangement in which each of the body and the lid portion include cooperating screw threads. The lid may be hingedly connected to the rigid body. The lid may be integrally formed with the body. Such an arrangement may be particularly advantageous if the body is made from polypropylene, or a similar plastics material, since polypropylene gives a very energetic hinge.

The insert may further comprise a pouring spout which is retained within the dispensing aperture. Provision of a pouring spout allows the contents of a container to be easily dispensed.

The insert may further comprise a portion having drainage holes, that portion extending, in use, into the container opening. Extending the insert into the container opening helps to improve the seal of the closure to the container and to mitigate chances of leakage. Projecting the insert into the container may lead to difficulties fully draining the contents of the container. Provision of drainage holes in the portion which extends into the container may allow full drainage of the contents of the container. The portion which extends, in use, into the container opening, may be crennellated.

The closure may further comprise a lid for closing the closure, connectable to the body. The lid may be hingedly connected to the body.

The lid may include a sealing column which fits into, or over the insert to provide a seal. Such an arrangement may assist with the leak resistance of the closure after first opening.

A further aspect provides a closure as hereinbefore described in combination with a container.

A further aspect of the present invention provides a method of forming a closure comprising: providing a body defining a dispensing aperture and comprising a jaw engageable with a lip, on a container having an opening, to secure said closure to said container; providing an insert comprising a sealing ring locatable within said dispensing aperture; arranging the jaw of the body to be operable to exert a clamping force on the sealing ring to retain the insert sealingly within the dispensing aperture.

Further particular and preferred aspects of the present invention are set out in the accompanying independent and dependent claims. Features of the dependent claims may be combined with the features of the independent claims as appropriate, and in combinations other than those explicitly set out in the claims.

### BRIEF DESCRIPTION OF DRAWINGS

Embodiments of the present invention will now be described further, with reference to the accompanying drawings, in which:

FIG. 1 illustrates a side elevation of a closure formed in accordance with the present invention;

FIG. 2 is a front elevation of the closure of FIG. 1;

FIG. 3 is a cut away cross section of the closure shown in FIG. 1 in position on a container;

FIG. 4 is an enlarged view of the region marked A in FIG. 3;

FIGS. 5A to 5C show a schematic illustration of a sequential moulding process suitable for moulding a closure as shown in FIG. 1;

FIG. 6A is a perspective view of a closure formed according to an alternative embodiment; and

FIG. 6B is a cut away view of the closure of FIG. 6A.

### DESCRIPTION OF THE EMBODIMENTS

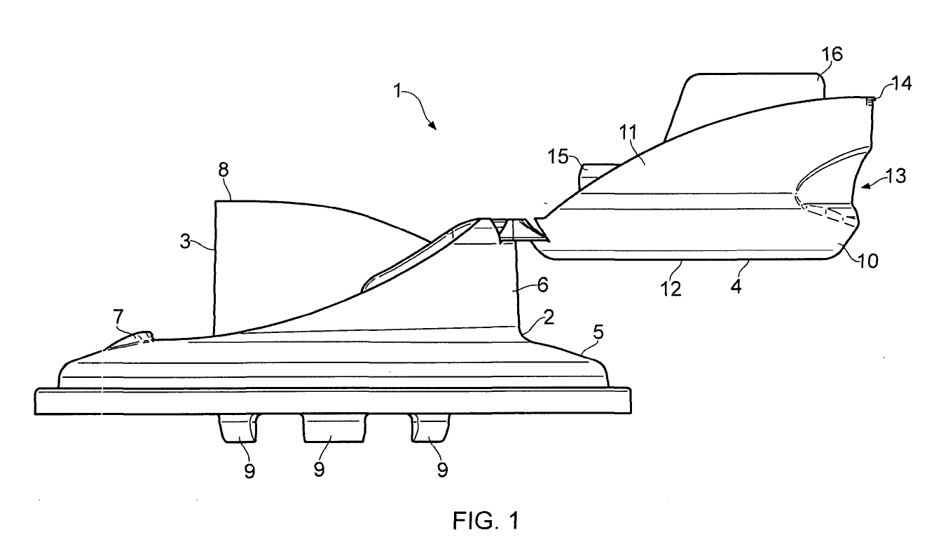

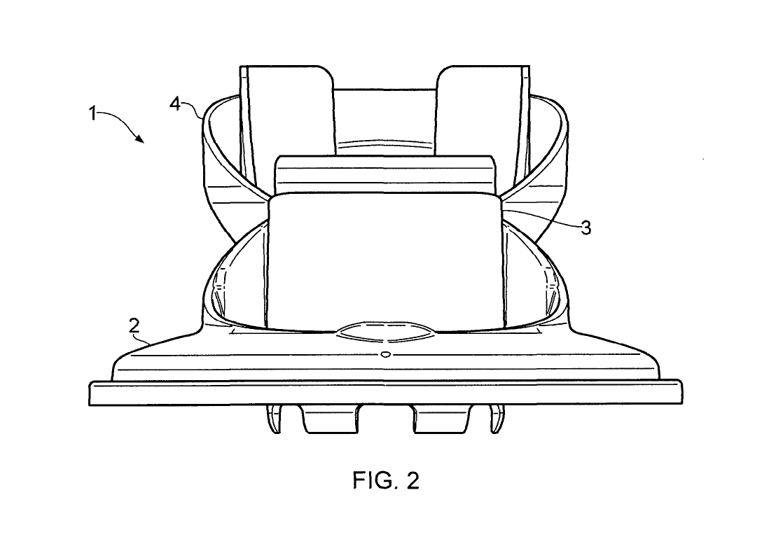

FIGS. 1 and 2 illustrate a closure formed in accordance with the present invention. The closure 1 comprises generally a body 2, a pouring spout 3 and a lid 4. The body 2 comprises a deck 5 which is substantially flat, a lid support 6 and, on the upper surface of the deck 5, there is also a lip 7 for engagement with the lid 4 when said lid is in a closed position.

The pouring spout 3 extends through the deck of the body 2 from a pouring lip 8 to a crennellated drainage portion 9.

The lid 4 comprises generally: a cap 10 which is substantially cylindrical. The cap itself has an outer wall 11 which depends from a substantially disc shaped top surface 12. The wall 11 includes a shaped recess 13 for engagement with, for example, a users thumb to allow easy opening of the closure. The lid 4 also comprises, at the bottom of wall 11, a lip 14 which engages with a corresponding lip provided on the body to hold the lid in a closed position.

On the inner surface of the cap 10 there is provided a depending sealing portion 15 which itself is substantially cylindrical. Surrounding the sealing portion 15 there is a guide portion 16 which assists with guiding the lid 4 over the pouring spout 3.

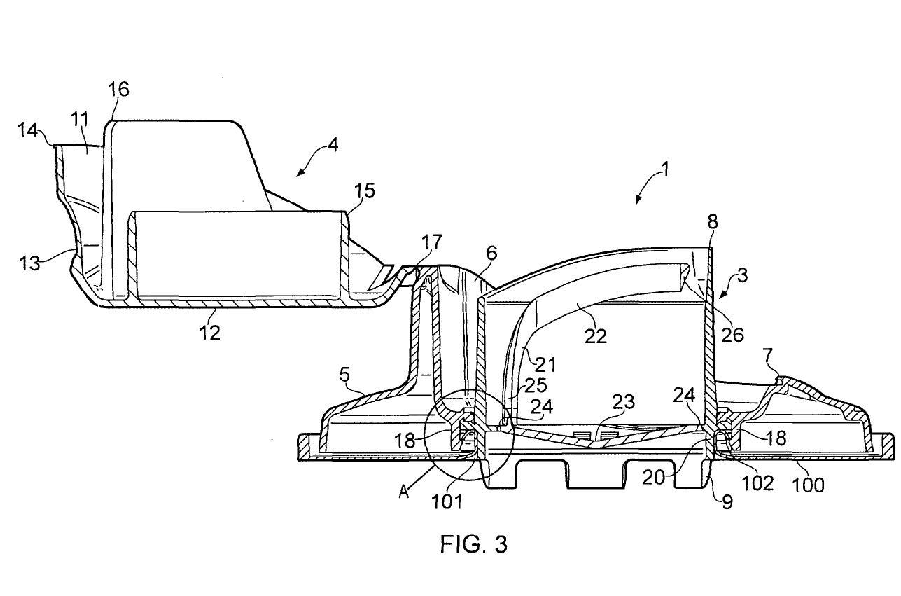

FIG. 3 is a cutaway cross section of the closure shown in FIGS. 1 and 2 in position on a container. A surface of the container 100 is shown including the closure 1. In this case, the surface 100 is formed from metal and defines an opening 101 which passes there through. At the edge of the opening 101 there is provided a portion of the surface which is rolled and forms a lip 102.

FIG. 3 shows the structure of closure 1 in more detail. In the embodiment shown, the body 2 and the lid 4 are integrally formed, and are hingedly connected by hinge 17. The deck 5 of the body 2 defines a hollow space between the top surface of the deck and the container surface 100. The body 2 includes a mounting arrangement 18, shown in more detail in FIG. 3.

FIG. 3 shows the structure of pouring spout 3 in more detail. The pouring spout passes through body 2. Between the pouring lip 8 and the crennellated portion 9, the pouring spout 3 includes a sealing arrangement 20 which lies adjacent to the lip 102 of the container.

Within the pouring spout 3 there is provided a tear-off portion 21. The tear off portion 21 comprises a ring pull 22 and a base 23. The base 23 is generally disc shaped and is integrally formed with pouring spout 3. The shape of the base is defined by a line of weakness 24 which is formed by any convenient means, for example, such as thinning of material or scoring. The ring pull comprises two spaced stalks 25 which extend from one edge of the base and are joined together by a semi circular hoop 26 which extends perpendicular to the stalks.

Removal of the tear off portion 21 occurs when the ring pull 22 is used to remove the base 23 from the pouring spout 3. When a force is applied to the ring pull 22 the base 23 is torn away along the line of weakening 24. The tear off portion 21 is, in the embodiment shown, fully removed from the pouring spout 3 to allow the contents of the container to be dispensed.

The interaction between the sealing arrangement 20 of the pouring spout 3 and the mounting arrangement 18 of the body with the lip 102 of the container is shown in more detail in FIG. 3.

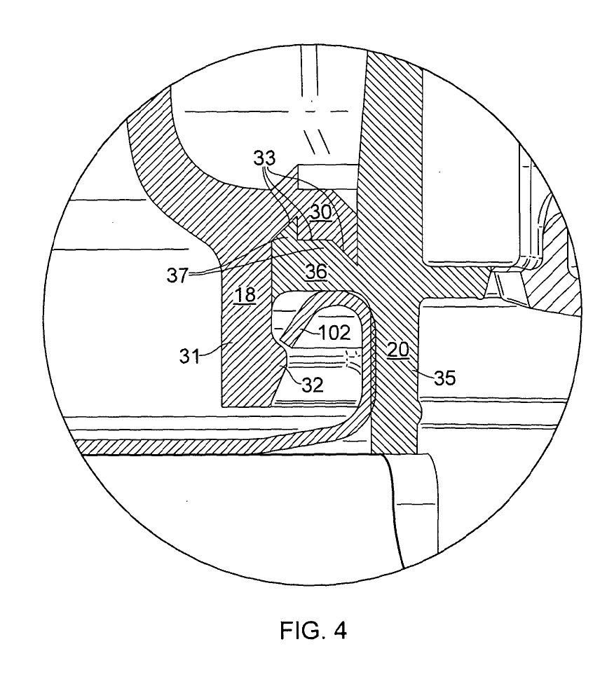

FIG. 4 is an enlarged view of the region marked A in FIG. 3. In the embodiment shown, the body 2 and pouring spout 3 are integrally formed despite being made of different plastics materials. The pouring spout 3 is formed from low density polyethylene which has particular advantages with respect to sealing and inclusion of the tear-off portion 21. The low density polyethylene is relatively resilient and therefore forms a good seal when inserted into the opening 101 in the container 100. The body is formed from polypropylene which is relatively rigid, and strong. Therefore making it suitable to form the bulk of the closure and in particular the lid since it protects the pouring spout 3 the polypropylene also provides a resilient hinge between the body and the lid. The body 2 and pouring spout 3 may be formed in one piece by means of a sequential moulding process which is described in more detail with reference to FIG. 4.

The mounting arrangement 18 of the body is substantially annular comprises an upper arm 30 and a lower arm 31. The lower arm 31 includes a protrusion 32 which forms a jaw arrangement with upper arm 30. The mounting arrangement further comprises keying features 33 provided on the lower side of the upper arm 30.

The sealing arrangement 20 of the pouring spout 3 comprises a cylindrical wall 35 arranged to sit adjacent to the edge of the opening 101 provided in the container. On the exterior surface of the cylindrical wall 35 there is provided a generally annular flange 36 which projects from the wall. The upper surface of the flange 36 comprises keying features 37 arranged to cooperate with the corresponding keying features 33 provided on the lower surface of the upper arm of the mounting arrangement 18. In use, the closure is located on the container such that the sealing arrangement and in particular the sealing cylindrical wall 35 is within the opening 101 defined by the container surface 100. The protrusion 32 provided on the mounting arrangement snap-fits beneath the lip 102 of the container if suitable top pressure is applied and secures the entire closure onto the container. The jaw arrangement of upper arm 30 and protrusion 32 acts to trap the protruding flange 36 and the lip of the container 102 between the jaws. The jaw exerts a retaining force on the flange 36 such as to retain the pouring spout 3 in position on the container and retains the sealing arrangement 20 of the spout within the dispensing aperture when the tear off portion 21 is removed.

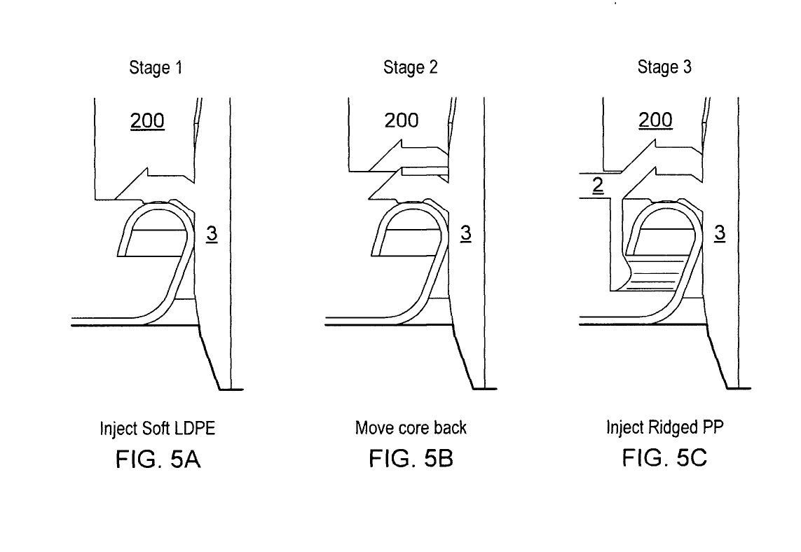

FIGS. 5A to 5C illustrate schematically a sequential moulding process suitable for moulding a closure in accordance with the present invention. FIG. 5A shows schematically how the soft low density polyethylene forming the pouring spout 3 is moulded in a first stage with mould piece 200 in position. Once a low density polyethylene piece forming the pouring spout is moulded, the mould 200 is moved back as shown in FIG. 5B. A second injection process is then carried out as shown in FIG. 5C, and polypropylene is injected around the polyethylene piece, to form the body 2. The assembly is then allowed to cool.

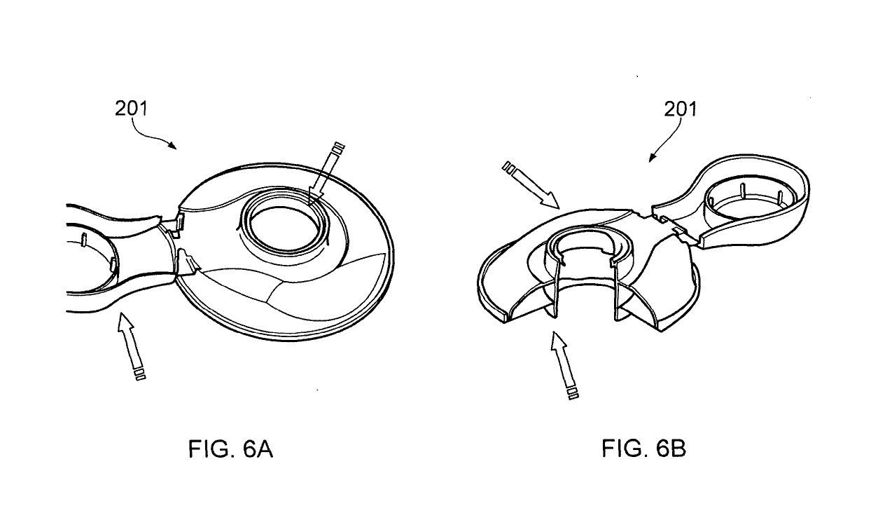

FIGS. 6A and 6B show a closure formed according to an alternative embodiment. The closure 201 is very similar to the closure shown in FIGS. 1 to 4. In this embodiment to insert is formed from low density polyethylene (LDPE) and the body is formed from high density polyethylene (HDPE).

In use the soft LDPE material forming the tear-off panel is trapped between the harder HDPE material of the closure and a container body e.g. a metal can.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1-14. (canceled)

15. A closure for a container, comprising:
a body and an insert; the insert having a retaining section for fitting it into the body and the section having a part engageable by a container neck such that the insert becomes trapped between the neck and the body in use, and in which the body includes a jaw portion which clamps onto the container to trap the insert.

16. A closure as claimed in claim 15, in which the body and insert are formed separately and assembled, connected or unconnected, onto a container.

17. A closure as claimed in claim 15, in which the body and insert are formed together.

18. A closure as claimed in claim 17 in which the body and insert are formed by sequential moulding.

19. A closure according to claim 18, wherein the jaw exerts a clamping force on the moulding interface between the body and insert.

20. A closure as claimed in claim 15, in which the retaining section is formed separately from the insert and is attached or attachable thereto.

21. A closure according to claim 15, in which the retaining section comprises a flange.

22. A closure according to claim 15, wherein the body is formed from a first material, and the insert is formed from a second material.

23. A closure according to claim 22, wherein the second material is more resilient than the first material.

24. A closure according to claim 15, wherein the insert further comprises a tear off portion removable to allow dispensing through said container opening, and the jaw exerts a clamping force on the sealing ring to retain the insert sealingly within the dispensing aperture when the tear off portion is removed.

25. A closure according to claim 15, wherein the body is formed from polypropylene or a plastics material having substantially similar properties.

26. A closure according to claim 15, wherein the insert is formed from low density polypropylene or a plastics material having substantially similar properties.

27. A closure according to claim 15, wherein the insert further comprises a portion having drainage holes which extends, in use, into the container opening.

28. A closure according to claim 15, in which said body defines a dispensing aperture, and further comprises a jaw engageable with a lip, on a container having an opening, to secure said closure to said container; and wherein said retaining section of said insert comprises a sealing ring locatable within said dispensing aperture, and wherein the jaw is operable to exert a clamping force on the sealing ring to retain the insert sealing within the dispensing aperture.

29. A closure as claimed in claim 15, in which the insert comprises a pouring spout.

30. A closure according to claim 15, in which the closure includes a lid.

31. A closure according to claim 30, in which the lid is hingedly connected to the body.

32. A container having a closure as claimed in claim 15.

33. A method of forming a closure for a container, said method comprising the steps of:
providing a body including a jaw portion;
providing an insert having a retaining section which fits the insert into the body, the retaining section having a part operable to be clampable by the jaw portion of the body, the retaining section and jaw portion being operable to trap the retaining section between a container neck and said body.

34. A method of forming a closure for a container, said method comprising the steps of:
moulding a pouring spout in a first stage;
moulding a body in a second stage; and
assembling the insert and body onto a container so that the part of the spout becomes trapped between the body and the container.
